(19) United States
(12) Patent Application Publication
(10) Pub. No.: US 2016/0227967 A1
(43) Pub. Date: Aug. 11, 2016

(54) Method and device for separating liquids from food products

(71) Applicant: Michele Cooper, Short Hills, NJ (US)

(72) Inventor: Michele Cooper, Short Hills, NJ (US)

(21) Appl. No.: 14/544,740

(22) Filed: Feb. 10, 2015

(51) Int. Cl. A47J 43/24; B65D 21/02; B65D 43/02; B65D 25/40

(52) U.S. Cl. CPC A47J 43/24; B65D 25/40; B65D 21/0233; B65D 43/02

(57) ABSTRACT

A device and method for separating liquids from food through the use of gravity. The device and method also provide the liquids separately so that it can be used for other purposes.

### FIELD OF THE INVENTION

The Present invention relates to a device and method for separating liquids from food through the use of gravity. The device and method also provide the liquids separately so that it can be used for other purposes.

### BACKGROUND OF THE INVENTION

When salads are kept in the refrigerator in a container, any dressing or other liquid coatings tend to cause the salad to become inedible in a short period of time.

When fruits such as watermelon or other fruits that have a strong liquid component are kept in a container in the refrigerator, they go bad quickly due to the fruit being kept in the released liquid content.

When tuna fish is kept in a container, it tends to go bad quickly due to the fact that it is sitting in the liquid.

### SUMMARY OF THE INVENTION

The present invention relates to a device and method for separating the liquid content of a food product that is kept in the refrigerator or other preserved environment. The present invention comprises a container that allows liquid to be released form a food product that is placed in the container and separated to a separate container. This is done by gravity such that the liquid portion drips off through the first container into a second container.

It is an object of the present invention for the first container where the food is placed to be in the form of a strainer or other container that has holes so that a liquid portion through gravity can go through the first container and into a second container.

It is an object of the present invention for the second container to be a solid container that holds the liquid that comes out of the first container.

It is an object of the present invention for the liquid that is contained in the second container to be separate and apart from the food product that is in the first container.

It is an object of the present invention for the second container to have a spout or other opening that allows the liquid to flow out of the second container.

It is an object of the present invention for the second container to be in two separate parts such that the lower part can be removed with the liquid contained therein. It is an object of the present invention to have a separate cover for the lower portion of the second container to preserve the liquid that is being removed.

It is an object of the present invention for the first container to be attached to the second container.

It is an object of the present invention for the first container to be removable from the second container. By having the containers being removable from each other, it is easier to clean the containers separately.

It is an object of the present invention to have a cover that covers the second container while having the first container sits within or outside the second container.

### BRIEF DESCRIPTION OF DRAWINGS

FIG. 1 shows a side cross-sectional view of an embodiment of the present invention.

FIG. 2 shows a side cross-sectional view of an embodiment of the present invention.

FIG. 3 shows a side cross-sectional view of an embodiment of the present invention.

FIG. 4 shows a side view of a second container of the present invention.

FIG. 5 shows a side view of a second container of the present invention.

FIG. 6 shows a side view of a first container of the present invention.

FIG. 7 shows an embodiment of an outside container separable into two parts of the present invention.

FIG. 8 shows the bottom part of the container shown in FIG. 7.

### DETAILED DESCRIPTION OF THE INVENTION

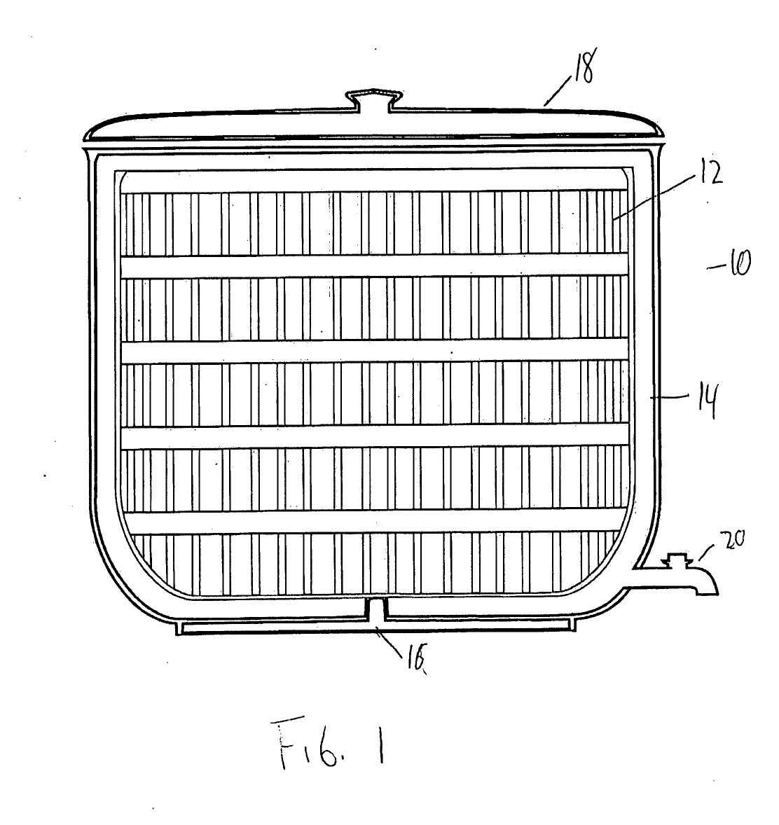

FIG. 1 shows an embodiment of the present invention 10 showing a first container 12 nestled inside a second container 14. The containers are held on a stand 16, a cover 18 covers both the first container 12 and second container 14. The second container 14 has a spout 20 for releasing any liquids out of the container.

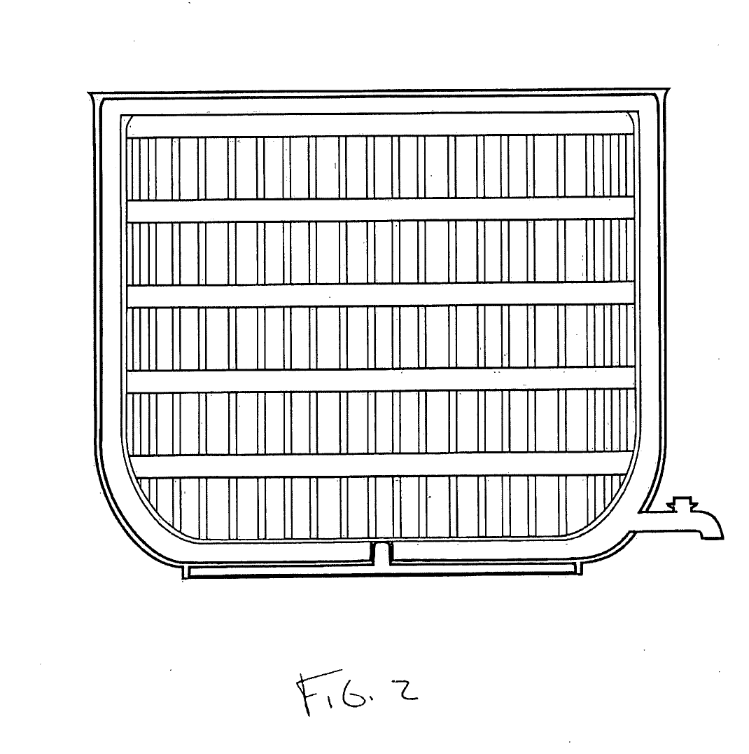

FIG. 2 shows the same embodiment of FIG. 1 not having the cover 18.

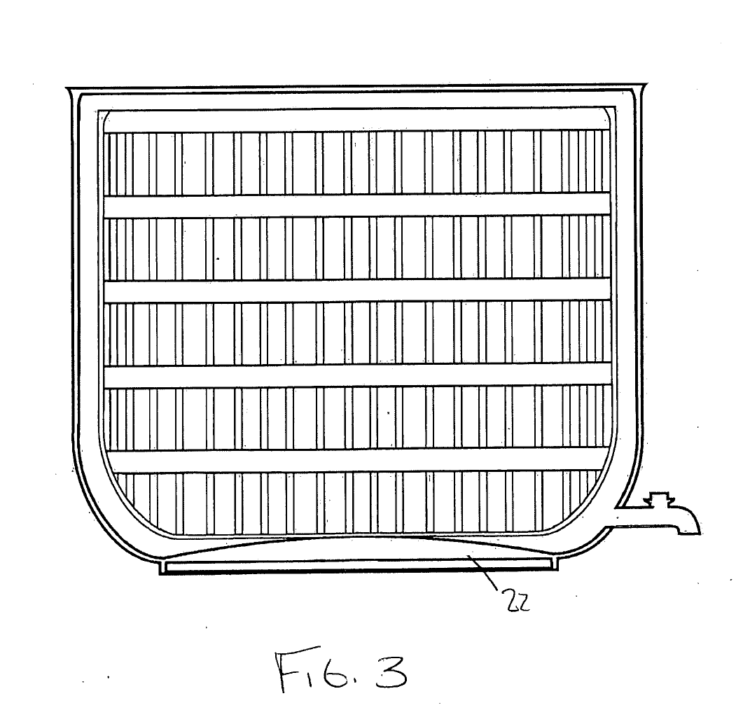

FIG. 3 shows the same containers as FIG. 1 except that is has a different stand mechanism 22.

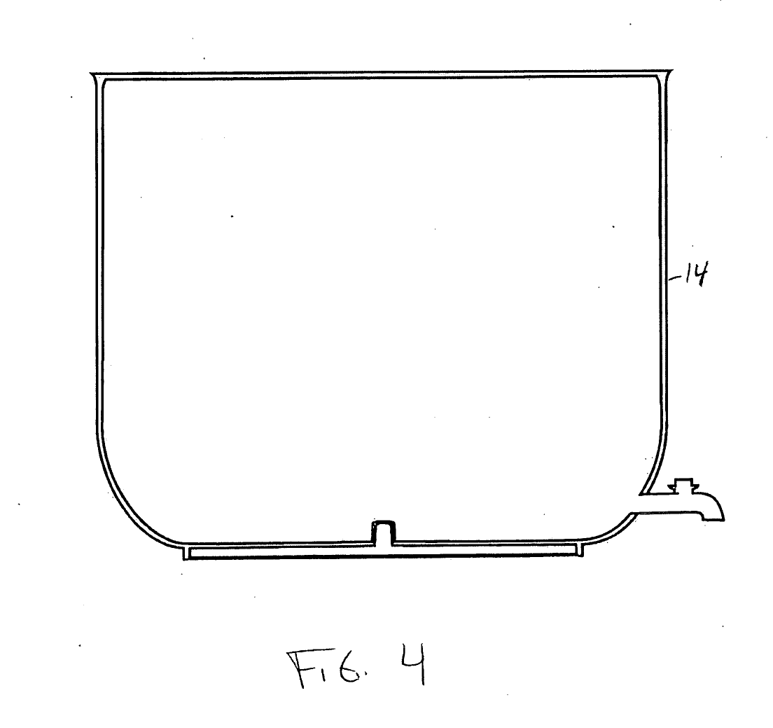

FIG. 4 shows the container 14 separate from the container 12 showing FIG. 1.

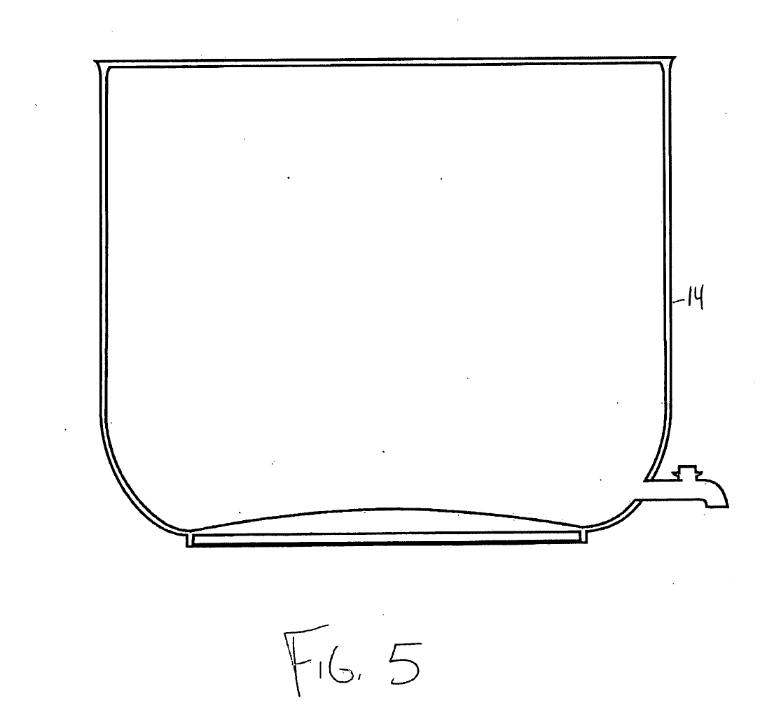

FIG. 5 shows a further embodiment showing container 14 without having the container 12 within it.

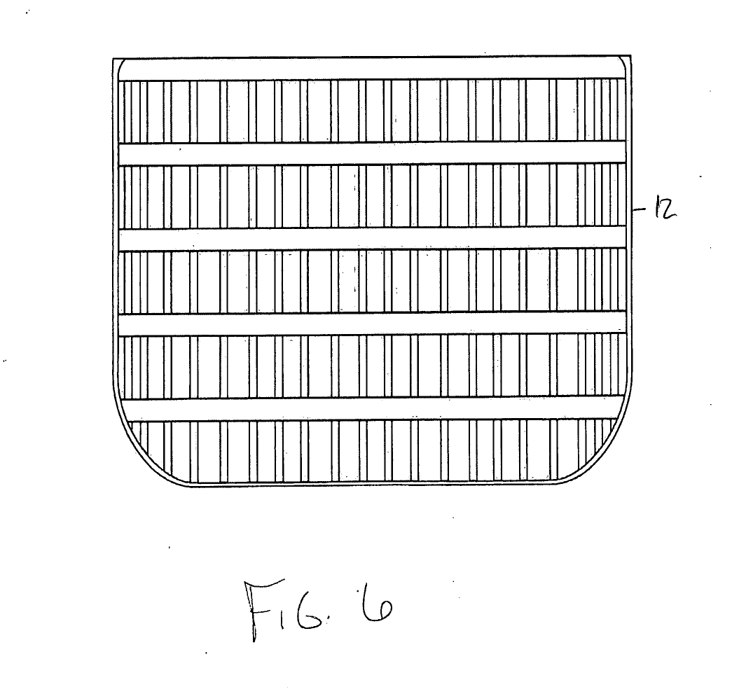

FIG. 6 shows the inner container 12 separate from the outer container 14.

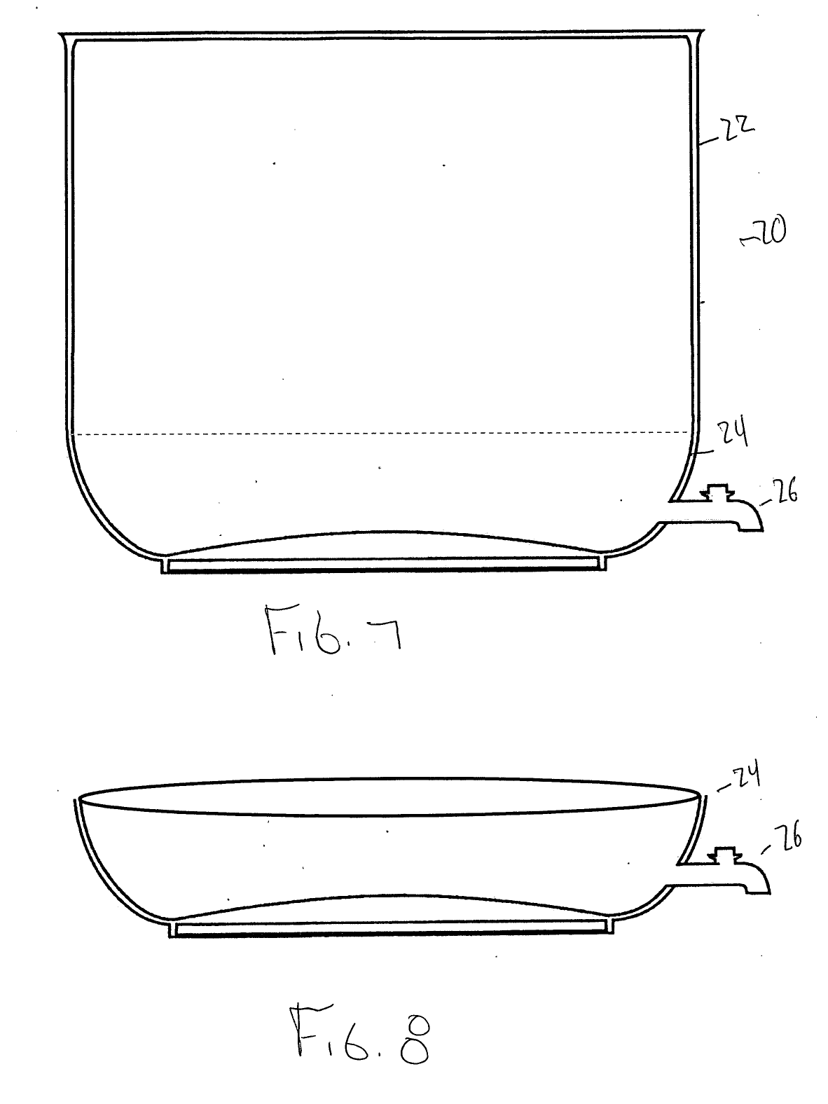

FIG. 7 shows an outer container 20 which has an upper section 22 and a lower section 24; the lower section 24 has a spout 26.

FIG. 8 shows the lower section 24 of the container 20 having a spout 26.

1. A device for separating liquid content of a food product comprising:
a first outside container and a second inside semi porous container;
said second container having liquid from a food product flow through it to said first container said first container keeping said liquid within it separate from said food product that is in said second container.

2. The device of claim 1 wherein said device is kept in a refrigerator or other preserved environment.

3. The device of claim 1 wherein gravity forces liquid out of said food product kept in said second container to flow to said first container.

4. The device of claim 1 wherein said second container is in form of a strainer or a container that has holes or openings.

5. The device of claim 1 wherein said second container is a solid container that holds said liquid flowing to it from said first container.

6. The device of claim 1 wherein said first container further comprise a spout or other opening for liquid to flow out of said second container.

7. The device of claim 1 wherein said second container comprises two separate sections such that a lower section is removed with liquid contained therein from an upper section of said second container.

8. The device of claim 7 further comprising a separate cover for said lower section of said second container.

9. The device of claim 1 wherein said first container is attached to said second container.

10. The device of claim 1 wherein said first container is removable from said second container.

11. The device of claim 10 wherein said containers are cleaned separately.

12. The device of claim 1 further comprising a cover that cover said second container while having said first container sit within or outside the second container.

13. The device of claim 1 further comprising a stand that said second container is held on.

14. A method of separating liquid from a food material comprising:
placing a food material in a semi-porous first container, wherein said first container is nestled within a solid second container;
releasing liquid out of said solid material via gravity into said second container;
releasing said liquid out of said second container via a spout or other opening.
